(19) United States
(12) Patent Application Publication
(10) Pub. No.: US 2007/0088479 A1
(43) Pub. Date: Apr. 19, 2007

(54) Apparatus with sensor assembly for sensing a vehicle crash condition and associated method

(75) Inventors: Michael C. McCarthy, Birmingham, MI (US); Xing Ping Lin, Orchard Lake, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/253,969

(22) Filed: Oct. 19, 2005

(51) Int. Cl. G06F 17/00

(52) U.S. Cl. 701/45; 701/301; 280/735

(57) ABSTRACT

An apparatus (10) and method for sensing a vehicle crash condition includes a transponder (76a) responsive to interrogation signals for providing response signals and a transceiver (70a) for transmitting interrogation signals to the transponder (76a) and receiving response signals from the transponder (76a). The transponder (76a) is affixed to a first structure (36) of the vehicle (12) and the transceiver (70a) is affixed to a second structure (64) of the vehicle (12) at a location spaced apart from the first structure (36). A characteristic of the response signals changes in response to a vehicle crash condition that causes relative movement between the first and second structures (36 and 64). The apparatus (10) also includes a controller (34) for monitoring the received response signals to determine whether a vehicle crash condition is occurring.

### TECHNICAL FIELD

The present invention relates to an apparatus for sensing a vehicle crash condition, and to an associated method. More particularly, the present invention relates to an apparatus that is responsive to relative movement between a transceiver and an associated transponder of a sensor assembly for sensing a vehicle crash condition, and to an associated method.

### BACKGROUND OF THE INVENTION

Actuatable vehicle occupant protection systems are well known in the art. Such occupant protection systems include one or more vehicle crash sensors for detecting the occurrence of a vehicle crash condition. When a vehicle crash condition is detected, the occupant protection system may actuate an inflatable device, such as an air bag, for helping to protect an occupant of the vehicle.

Known vehicle crash sensors include mechanical devices, such as switches, that close in response to deformation of the vehicle. The closure of the mechanical device indicates the occurrence of a vehicle crash condition. Other known vehicle crash sensors are electrical devices, such as accelerometers. When a processed output of the electrical device crosses a threshold level, a vehicle crash condition is determined.

Vehicle crash sensors for detecting a side impact to a vehicle must have particularly rapid response times as the time period for actuating an inflatable device for occupant protection during a side impact is significantly less than the time period for actuating an inflatable device for occupant protection during a frontal impact. To help improve the response time of a vehicle crash sensor for sensing side impacts, it is common to locate the vehicle crash sensor at the side of the vehicle, such as on a side pillar or within the door of the vehicle.

Some difficulties arise when the vehicle crash sensor is located within the door of the vehicle. For example, the vehicle crash sensor must be able to sense a side impact, but must be immune to actions such as door slams. Also, a vehicle crash sensor within the door must be immune to low force impacts to the door such as those common when a door is opened into an object.

Radio frequency identification (RFID) systems are also known. RFID systems are commonly used in industries requiring the tracking of products. RFID systems include a transceiver (sometimes called a “reader”), a transponder (sometimes called a “tag”), and a processor. The transponder includes a unique identification and is secured to a product to be tracked. When the transponder is passed through a magnetic field transmitted by the transceiver, the transponder transmits a signal to the transceiver that includes its unique identification. The transceiver receives the signal including the unique identification and, the processor tracks the product using the unique identification. In RFID systems in which the transceiver and the transponder are inductively coupled, a magnetic field emitted by the transceiver decreases in power in proportion to 1/d³, in which d is the distance from the transceiver.

### SUMMARY OF THE INVENTION

The present invention relates to an apparatus for sensing a vehicle crash condition. The apparatus comprises a transponder that is responsive to interrogation signals for providing response signals. The transponder is affixed to a first structure of the vehicle. The apparatus also comprises a transceiver for transmitting interrogation signals to the transponder and receiving response signals from the transponder. The transceiver is affixed to a second structure of the vehicle at a location spaced apart from the first structure. A characteristic of the response signals received at the transceiver changes in response to a vehicle crash condition that causes relative movement between the first and second structures. The apparatus further comprises a controller for monitoring the received response signals to determine whether a vehicle crash condition is occurring.

According to another aspect, the present invention relates to a method for sensing a vehicle crash condition. The method comprises the step of: transmitting interrogation signals to a transponder affixed to a first structure of the vehicle from a transceiver affixed to a second structure of the vehicle. The second structure of the vehicle is spaced apart from the first structure. The method also comprises the steps of: transmitting response signals from the transponder to the transceiver in response to receiving the transmitted interrogation signals; and receiving the response signals at the transceiver. A characteristic of the response signals received at the transceiver changes in response to a vehicle crash condition that causes relative movement between the first and second structures. The method further comprises the step of monitoring the received response signals to determine whether a vehicle crash condition is occurring.

### BRIEF DESCRIPTION OF THE DRAWINGS

The foregoing features and advantages of the present invention will become apparent to those skilled in the art to which the present invention relates upon reading the following description with reference to the accompanying drawings, in which:

FIG. 1 illustrates an apparatus constructed in accordance with an example of an embodiment of the present invention and mounted in a vehicle;

FIG. 2 illustrates a section view of a door of the vehicle in a non-deformed condition with a sensor assembly of the apparatus located within a cavity of the door;

FIG. 3 illustrates a section view of the door in a deformed condition with the sensor assembly of the apparatus located within the cavity of the door;

FIG. 4 schematically illustrates the apparatus of FIG. 1;

FIG. 5 schematically illustrates receive circuitry of a transceiver of the apparatus;

FIG. 6 schematically illustrates a transponder of the apparatus; and

FIG. 7 is a flow diagram of an example of a process performed by the apparatus of the present invention.

### DETAILED DESCRIPTION OF THE INVENTION

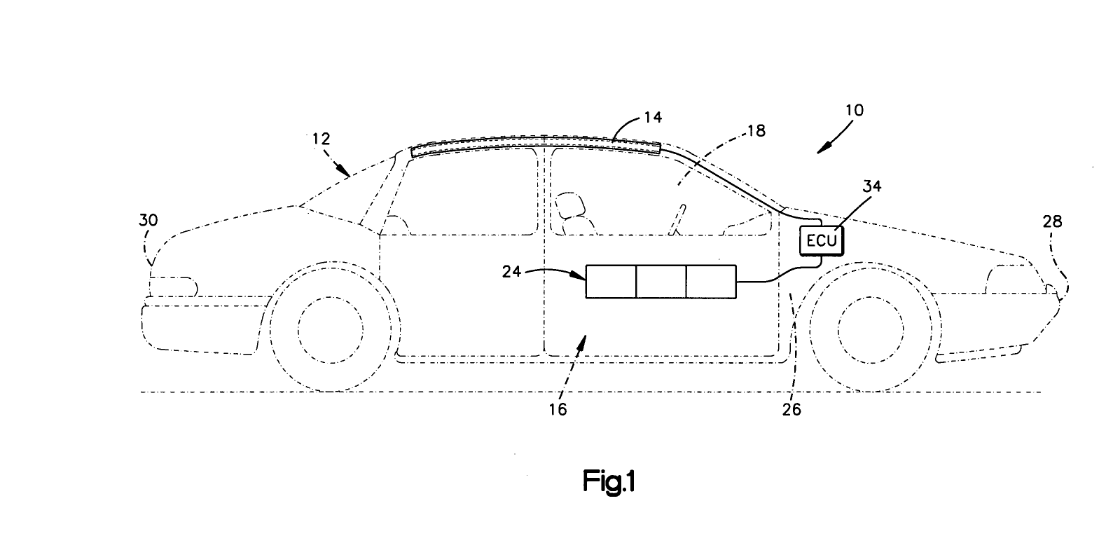

FIG. 1 illustrates an apparatus 10 constructed in accordance with an example of an embodiment of the present invention. The apparatus 10 of FIG. 1 is mounted in a vehicle 12 and is operable for sensing a vehicle crash condition and for controlling an actuatable occupant protection system 14. The actuatable occupant protection system 14 illustrated in FIG. 1 is an inflatable side curtain. As an alternative to the inflatable side curtain, the actuatable occupant protection system 14 may include one or more of an inflatable air bag, an inflatable seat belt, an inflatable knee bolster, an inflatable head liner, a knee bolster operated by an inflatable air bag, or any other type of actuatable occupant protection device.

The inflatable side curtain 14 of FIG. 1, upon being actuated, inflates into a position covering a portion of the side structure of the vehicle 12 for helping to protect an occupant (not shown) of the vehicle. The side structure of the vehicle 12 illustrated in FIG. 1 includes a door 16 and its associated window 18.

The apparatus 10 includes a sensor assembly 24. FIG. 1 schematically illustrates the sensor assembly 24 located within the door 16 of the vehicle 12. When the sensor assembly 24 is located within the door 16, the vehicle crash condition that the apparatus 10 senses is a side impact to the vehicle 12. Although the sensor assembly 24 is located within the door 16 in the embodiment of FIG. 1, the sensor assembly 24 may be located at other locations of the vehicle 12. For example, the sensor assembly 24 may be located within a side panel 26 of the vehicle 12 adjacent to the door 16 for sensing a side impact to the vehicle. Alternatively, the sensor assembly 24 may be located at the front 28 of the vehicle 12 for sensing a frontal impact to the vehicle or at the rear 30 of the vehicle for sensing a rear impact to the vehicle.

The apparatus 10 also includes an electron control unit 34 (“ECU”) that is operatively connected to the sensor assembly 24. The ECU 34 may be a microcomputer or any other type of controller for monitoring signals from the sensor assembly 24, for determining whether a vehicle crash condition is occurring, and for controlling actuation of the occupant protection system 14.

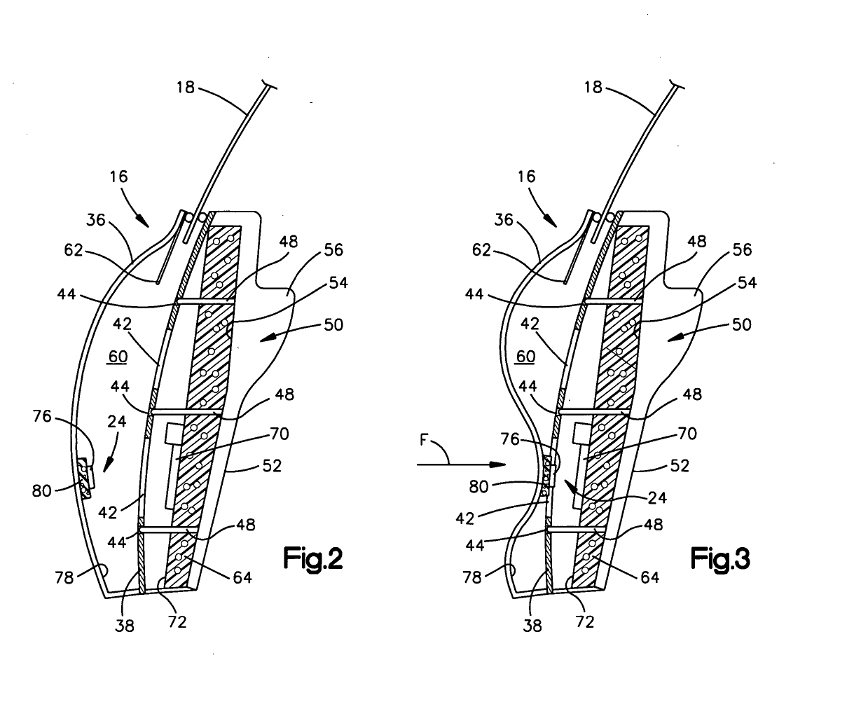

FIG. 2 illustrates a sectional view of the door 16 in a non-deformed (i.e., non-crash) condition. The door 16 includes an exterior panel 36 and a central support 38. The central support 38 includes through-holes 42 for helping to reduce the weight of the door 16. The central support 38 also includes apertures 44 for receiving and securing support legs 48 of a trim portion 50 of the door 16. The trim portion 50 forms the interior portion of the door 16 and includes opposite interior and exterior surfaces 52 and 54, respectively. An armrest 56 is formed on the interior surface 52 of the trim portion 50. The support legs 48 extend outwardly from the exterior surface 54 of the trim portion 50.

A cavity 60 is located within the door 16. The cavity 60 separates the exterior panel 36 and the trim panel 50 of the door 16. A sheath 62 is located in the cavity 60 between the exterior panel 36 and the central support 38. The sheath 62 receives a portion of the window 18 when the window is lowered. A sound deadening material 64 is also located within the cavity 60. FIG. 2 illustrates the sound deadening material 64 affixed to the exterior surface 54 of the trim portion 50. Mechanisms (not shown) for operating latches (not shown) of the door 16 and for lowering and raising the window 18 are located within the cavity 60.

The sensor assembly 24 of the apparatus 10 is also located within the cavity 60 of the door 16. FIG. 2 illustrates a transceiver portion 70 of the sensor assembly 24 affixed to an exterior surface 72 of the sound deadening material 64. The transceiver portion 70 of the sensor assembly 24 is located on the sound deadening material 64 at a location substantially aligned with a through-hole 42 in the central support 38.

FIG. 2 also illustrates a transponder portion 76 of the sensor assembly 24 secured relative to an interior surface 78 of the exterior panel 36 of the door 16. The transponder portion 76 is affixed to a foam rubber mount 80 that spaces the transponder portion 76 away from and electrically isolates the transponder portion from the exterior panel 36 of the door 16. The transponder portion 76 is mounted to the exterior panel 36 in a location aligned with the through-hole 42 and with the transceiver portion 70. The transceiver portion 70 and the transponder portion 76 may be aligned with one another through multiple through-holes 42. Alternatively, the transceiver portion 70 may be mounted on a surface of the central support 38 nearest the exterior panel 36.

When a side impact to the vehicle 12 occurs, a force F (FIG. 3) acts to deform the exterior panel 36 of the door 16 inwardly toward the central support 38. The sensor assembly 24 is operable for sensing this deformation of the exterior panel 36 of the door 16 and for providing sensor signals to the ECU 34 that are indicative of the sensed deformation.

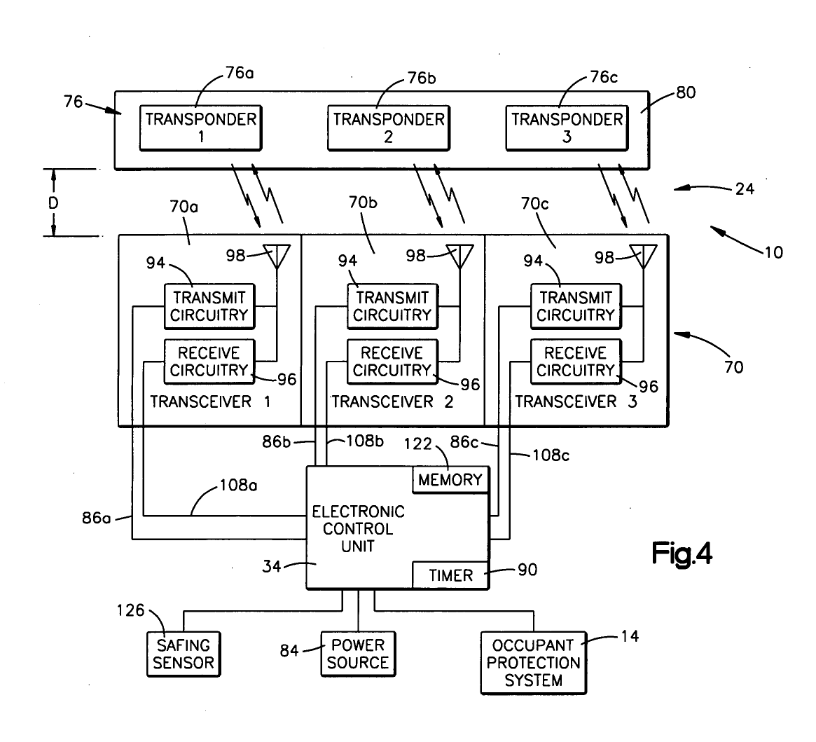

FIG. 4 schematically illustrates the apparatus 10 of the present invention. The transceiver portion 70 of the apparatus 10 illustrated in FIG. 4 includes three transceivers 70a, 70b, and 70c and the associated transducer portion 76 includes three transponders 76a, 76b, and 76c. Any number of transceivers and associated transponders may be used. When multiple transceivers and associated transponders are used, the area over which deformation is sensed increases. For example, with reference to FIG. 1, the sensor assembly 24 of FIG. 4, with three transceivers 70a, 70b, and 70c and three transponders 76a, 76b, and 76c, senses deformation over an area that extends across approximately sixty-percent of the longitudinal length, from left to right as viewed in FIG. 1, of the door 16.

With reference to FIG. 4, the three transceivers 70a, 70b, and 70c of the transceiver portion 70 operate at different frequencies from one another. By operating at different frequencies, cross-talk between the transceivers 70a, 70b, and 70c is avoided. In one embodiment, transceiver 70a and its associated transponder 76a operate at a frequency of 4.91 MHz; transceiver 70b and its associated transponder 76b operate at a frequency of 3.58 MHz; and transceiver 70c and its associated transponder 76c operate at a frequency of 2.00 MHz.

The ECU 34 of the apparatus 10 receives power from a power source 84, such as the battery of the vehicle 12 and an appropriate voltage regulator (not shown). The ECU 34 outputs power to the transceivers 70a, 70b, and 70c of the transceiver portion 70 via appropriate transmission lines, shown schematically at 86a, 86b, and 86c. In the embodiment illustrated in FIG. 4, the ECU 34 includes an internal timer 90. The ECU 34 is responsive to the timer 90 for provided pulses of electrical energy to the transceivers 70a, 70b, and 70c at timed intervals. For example, the ECU 34 may provide five to ten microsecond pulses of electrical energy to each transceiver 70a, 70b, and 70c at one hundred microsecond intervals.

Each transceiver 70a, 70b, and 70c of the transceiver portion 70 of the sensor assembly 24 includes transmit circuitry 94, receive circuitry 96, and an antenna 98. The transmit circuitry 94 is operatively coupled to the ECU 34 and includes a direct current (“DC”) to alternating current (“AC”) converter (not shown), such as an oscillator, for providing an oscillating signal at the appropriate frequency. The DC to AC converter receives the direct current from the ECU 34. The transmit circuitry 94 of each transceiver 70a, 70b, and 70c also may include components (not shown), such as amplifiers and filters. The transmit circuitry 94 outputs to the associated antenna 98 of the transceiver 70a, 70b, or 70c interrogation signals to be transmitted.

The antenna 98 of each transceiver 70a, 70b, and 70c transmits interrogation signals to its associated transponder 76a, 76b, and 76c. In an example of an embodiment of the present invention, the antenna 98 is a coil that is configured for providing a magnetic field at the appropriate frequency for inductively coupling the transceiver 70a, 70b, or 70c and its associated transponder 76a, 76b, or 76c. The antenna 98 is also configured to receive response signals from the associated transponder 76a, 76b, or 76c and to transfer the received response signals to the receive circuitry 96 of the transceiver 70a, 70b, or 70c.

FIG. 5 schematically illustrates an embodiment of the receive circuitry 96 of the transceivers 70a, 70b, and 70c. The receive circuitry 96 includes rectifying and regulating circuitry 104 for receiving the response signal from the antenna 98, converting the alternating current of the received response signal to direct current, and outputting a regulated direct current signal. The rectifying and regulating circuitry 104 provides the regulated direct current signal to a peak detector 106. The peak detector 106 receives the regulated direct current signal and outputs a sensor signal indicative of the peak amplitude of the received response signal. Any type of known peak detector 106 may be used in the receive circuitry 96 of the transceivers 70a, 70b, and 70c. The sensor signal output from the peak detector 106 is provided to the ECU 34 via appropriate transmission lines, shown schematically in FIG. 4 at 108a, 108b, and 108c.

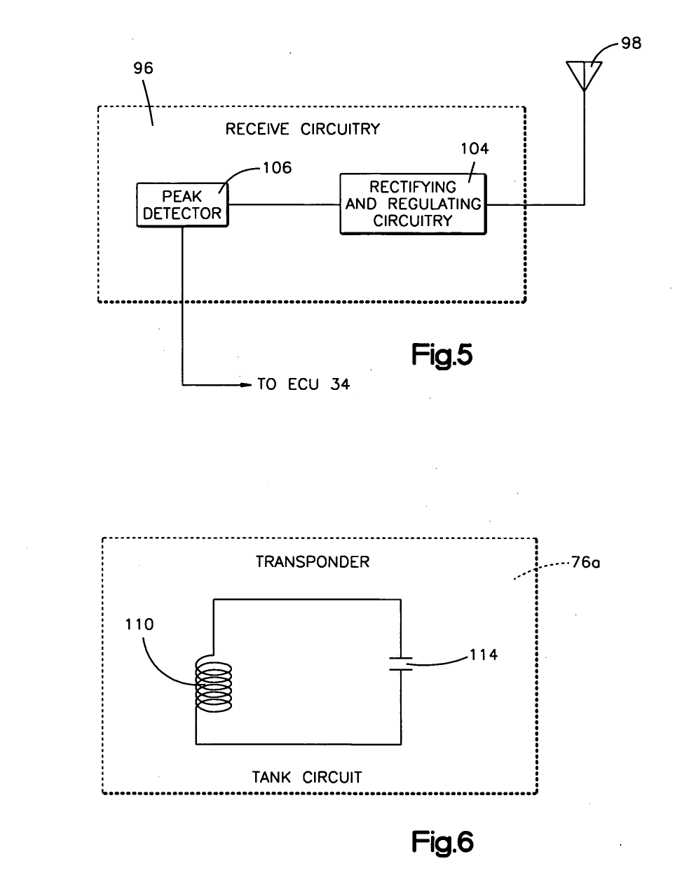

The transponders 76a, 76b, and 76c of the transponder portion 76 of the sensor assembly 24 are passive RF tags. FIG. 4 illustrates the three transponders 76a, 76b, and 76c mounted on a single foam rubber mount 80. Alternatively, separate foam rubber mounts may be used for each transponder 76a, 76b, and 76c. Each transponder 76a, 76b, and 76c has a frequency that corresponds to the frequency of the transceiver 70a, 70b, and 70c to which it is associated. FIG. 6 schematically illustrates transponder 76a of the transponder portion 76 of the apparatus 10. The transponder 76a includes a tank circuit with parallel connected inductor 110 and capacitor 114 in which the inductor 110 forms an antenna.

The antenna 110 is configured to be magnetically coupled to the antenna 98 of the transceiver 70a to which the transponder 76a is associated. The antenna 110 is a coil in which electric energy is induced when the transceiver 70a outputs a magnetic field thereby causing the tank circuit to oscillate. The transponder 76a provides a response signal via the antenna 110 for transmission back to the transceiver 70a at the appropriate frequency, i.e., 4.91 MHz. The tank circuit forms an RF tag. Those skilled in the art will appreciate that an RFID tag may be used.

As set forth above, when the antenna 98 of the transceiver 76a receives the transmitted response signal, the receive circuitry 96 determines a peak amplitude of the response signal and outputs a sensor signal indicative of the peak amplitude to the ECU 34. The ECU 34, upon receiving a sensor signal from a transceiver 70a, compares the sensor signal to reference values stored in a memory 122 (FIG. 4). The reference values correlate the amplitude of a received sensor signal to an associated distance separating the transceiver 70a from its associated transponder 76a. The ECU 34 is responsive to the comparison of the sensor signal and the reference values for determining whether deformation of the vehicle 12 indicating a crash event is occurring.

Table 1, below, shows a correlation between the peak voltage of a response signal received at a transceiver 70a, 70b, or 70c and the distance between the transceiver 70a, 70b, or 70c and its associated transponder 76a, 76b, or 76c. The data of Table 1 was obtained using a transceiver and associated transponder operating at 4.6 MHz.

TABLE 1

| Distance (inches) | Peak Voltage (VDC) |
|---|---|
| 5.5 | 0.2 |
| 5 | 0.21 |
| 4.5 | 0.24 |
| 4 | 0.36 |
| 3.5 | 0.9 |
| 3 | 1.8 |
| 2.5 | 2.5 |
| 2 | 2.7 |
| 1.5 | 2.9 |
| 1 | 3.0 |
| 0.5 | 3.0 |
| 0 | 3.0 |

For illustrative purposes, assume that the sensor assembly 24 from which the data of Table 1 was obtained is located in the door 16 of the vehicle 12 and that the distance separating the transponder portion 76 and the transceiver portion 70 of the sensor assembly 24 is 5.5 inches when the door 16 is in the non-deformed condition illustrated in FIG. 2. Also, assume that when the door 16 of the vehicle 12 is in the deformed condition illustrated in FIG. 3, the distance separating the transponder portion 76 and the transceiver portion 70 of the sensor assembly 24 is 1.0 inches. When the door 16 is in the non-deformed condition, the sensor signal from the transceivers 70a, 70b, and 70c of the transceiver portion 70 will have a peak voltage of 0.2 volts. In response to receiving a sensor signal having a peak voltage of 0.2 volts, the ECU 34 determines that no vehicle crash condition is occurring. When the door 16 is in the deformed condition of FIG. 3, the sensor signal from the transceivers 70a, 70b, and 70c of the transceiver portion 70 will have a peak voltage of 3.0 volts. In response to receiving a sensor signal having a peak voltage of 3.0 volts, the ECU 34 determines that a vehicle crash condition is occurring. The ECU 34 may determine a vehicle crash condition is occurring when the peak voltage has any value greater than the initial, non-deformed value, e.g., 0.2 volts.

In response to determining that a vehicle crash condition is occurring, the ECU 34 controls actuation of the occupant protection system 14 for helping to protect an occupant of the vehicle 12. To prevent actuation of the occupant protection system 14 during the occurrence of a low force impact or a deformation of the exterior panel 36 of the door 16, as may occur when the door is opened into an object, the apparatus 10 may also include a safing sensor 126 (FIG. 4). Preferably, the safing sensor 126 is an accelerometer that outputs acceleration signals indicative of acceleration of the vehicle 12 along an axis transverse to the direction of travel of the vehicle 12, i.e., along a side-to-side axis of the vehicle. The ECU 34 processes the acceleration signals output from the safing sensor 126 for determining whether the acceleration signals also indicate a vehicle crash condition for which actuation of the occupant protection system 14 is desired. When the apparatus 10 includes a safing sensor 126, the ECU 34 actuates the occupant protection system 14 only in response to signals from both the sensor assembly 24 and the safing sensor 126 indicating a vehicle crash condition for which actuation of the occupant protection system is desired.

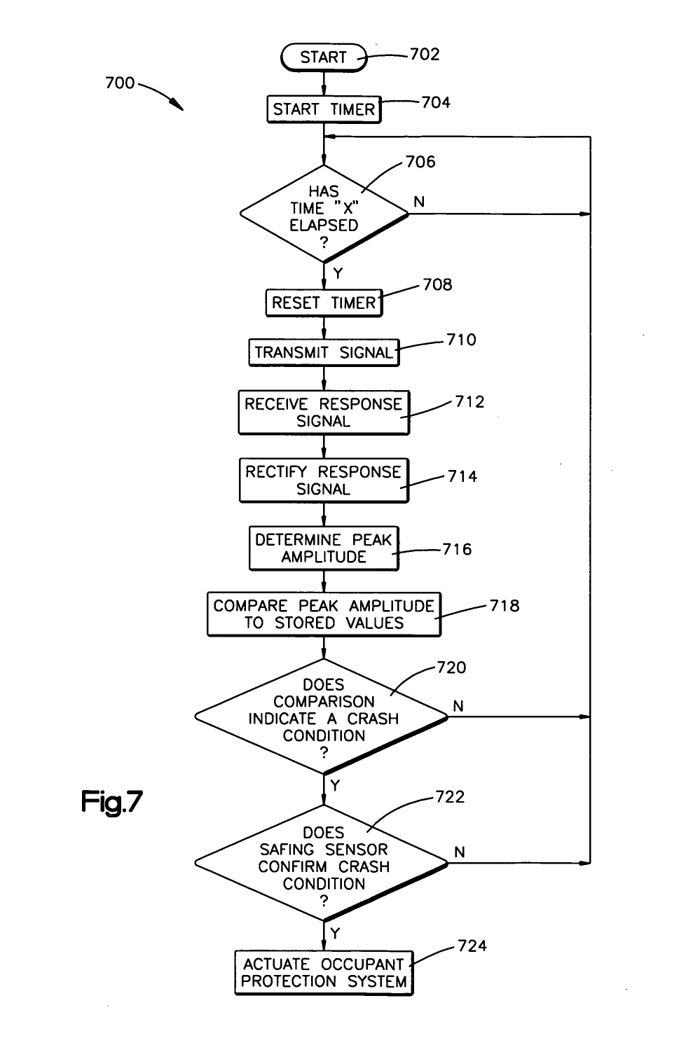

FIG. 7 is a flow diagram of a process 700 performed by the apparatus 10 of the present invention. The process 700 is initialized at step 702. During initialization, diagnostics of the apparatus 10 occurs, initial flag conditions are set, etc. Initialization may occur each time an ignition of the vehicle 12 is started. At step 704, the timer 90 of the ECU 34 is started. At step 706, a determination is made as to whether time X has elapsed since the timer 90 was started. The time X is the time interval between transmissions of signals from the transceiver portion 70. The time X may be adjusted. In one embodiment of the invention, time X is fifty milliseconds. When the determination at step 706 is negative, the process 700 returns to step 706 until an affirmative determination is made.

When the determination at step 706 is affirmative, the process 700 proceeds to step 708 and the timer 90 is reset. At step 710, the transceiver portion 70 of the sensor assembly 24 transmits signals to the transponder portion 76. From step 710, the process 700 proceeds to step 712 in which the transceivers 70a, 70b, and 70c of the transceiver portion 70 listen for and receive response signals from their associated transponders 76a, 76b, and 76c of the transponder portion 76.

At step 714, the received response signals are rectified. The peak amplitude of the rectified response signals is determined at step 716. At step 718, the peak amplitude of the response signals is compared to stored reference values and, at step 720, a determination is made as to whether the comparison indicates the occurrence of a crash condition. When the determination at step 720 is negative, the process 700 returns to step 706. When the determination at step 720 is affirmative and the comparison indicates the occurrence of a crash condition, the process 700 proceeds to step 722.

At step 722, a determination is made as to whether the safing sensor 126 indicates the occurrence of a crash condition. When the determination at step 722 is negative, the process 700 returns to step 706. When the determination at step 722 is affirmative and the safing sensor 126 also indicates the occurrence of a crash condition, the process 700 proceeds to step 724 and the occupant protection system 14 is actuated.

When the sensor assembly 24 of the apparatus 10 includes multiple transceivers and associated transponders, the transmission of signals from the transceivers to the transponders may be alternating. For example, when the sensor assembly 24 includes three transceivers 70a, 70b, and 70c and associated transponders 76a, 76b, and 76c, the second transceiver 70b may transmit a predetermined time after the first transceiver 70a and, the third transceiver 70c may transmit a predetermined time after the second transceiver 70b. In one example, the transceivers 70a, 70b, and 70c transmit at forty-five millisecond intervals, with the second transceiver 70b transmitting fifteen milliseconds after the first transceiver 70a and, the third transceiver 70c transmitting fifteen milliseconds after the second transceiver 70b.

In one embodiment of the invention, the ECU 34 may determine which transceiver or transceivers provided sensor signals indicating the occurrence of a crash condition. The ECU 34 may determine a type of crash condition from the determination and provide appropriate control of the occupant protection system 14. For example, when only transceiver 70b indicates the occurrence of a crash condition, the ECU 34 may determine that the side of the vehicle 12 impacted a pole, such as a utility pole.

From the above description of the invention, those skilled in the art will perceive improvements, changes and modifications. Such improvements, changes and modifications within the skill of the art are intended to be covered by the appended claims.

Having described the invention, we claim the following:

1. An apparatus for sensing a vehicle crash condition, the apparatus comprising:
a transponder responsive to interrogation signals for providing response signals, the transponder being affixed to a first structure of the vehicle;
a transceiver for transmitting interrogation signals to the transponder and receiving response signals from the transponder, the transceiver being affixed to a second structure of the vehicle at a location spaced apart from the first structure, a characteristic of the response signals received at the transceiver changing in response to a vehicle crash condition that causes relative movement between the first and second structures; and
a controller for monitoring the received response signals to determine whether a vehicle crash condition is occurring.

2. The apparatus of claim 1 wherein amplitude is the characteristic of the response signals that changes, the controller monitoring the amplitude of the response signals for determining whether a vehicle crash condition is occurring.

3. The apparatus of claim 2 wherein the controller has an associated memory in which are stored reference values for the response signals, the controller comparing the response signals to the stored reference values for determining whether a vehicle crash condition is occurring.

4. The apparatus of claim 2 wherein the transceiver includes a detector for detecting the amplitude of the response signals and for providing the controller with sensor signals indicative of the detected amplitude.

5. The apparatus of claim 4 wherein the detector is a peak detector for determining a peak amplitude of the response signal.

6. The apparatus of claim 1 wherein the first structure is an exterior panel of a door of the vehicle and the second structure is another portion of the door, the exterior panel being moved in response to an impact into the door.

7. The apparatus of claim 6 wherein the door includes a central support having multiple openings, the transponder being located on a first side of the central support and the transceiver being located on a second side of the central support, the transponder and transceiver being aligned with one another through at least one of the openings of the central support.

8. The apparatus of claim 6 wherein a foam rubber mount spaces the transponder away from and electrically isolates the transponder from the exterior panel of the door.

9. The apparatus of claim 1 further including a safing sensor for sensing acceleration of the vehicle and providing safing signals to the controller, the controller determining the occurrence of a vehicle crash condition when both the response signals and the safing signals indicate a vehicle crash condition.

10. The apparatus of claim 1 wherein the transponder is a first transponder and the transceiver is a first transceiver, the apparatus further including a second transponder that is associated with a second transceiver, the second transponder being spaced apart from the first transponder.

11. The apparatus of claim 10 wherein the first transponder and the first transceiver operate at a first frequency, the second transponder and the second transceiver operating at a second frequency different from the first frequency.

12. The apparatus of claim 10 wherein a foam rubber mount spaces the first and second transponders away from and electrically isolates the first and second transponders from the first structure.

13. A method for sensing a vehicle crash condition, the method comprising the steps of:
transmitting interrogation signals to a transponder affixed to a first structure of the vehicle from a transceiver affixed to a second structure of the vehicle, the second structure of the vehicle being spaced apart from the first structure;
transmitting response signals from the transponder to the transceiver in response to receiving the transmitted interrogation signals;
receiving the response signals at the transceiver, a characteristic of the response signals received at the transceiver changing in response to a vehicle crash condition that causes relative movement between the first and second structures; and
monitoring the received response signals to determine whether a vehicle crash condition is occurring.

14. The method of claim 13 wherein amplitude is the characteristic of the response signals that changes, the step of monitoring the received response signals further including the step of monitoring the amplitude of the response signals for determining whether a vehicle crash condition is occurring.

15. The method of claim 14 further including the steps of:
storing reference values for the response signals in a memory; and
comparing the received response signals to the stored reference values for determining whether a vehicle crash condition is occurring.

16. The method of claim 13 further including the step of mounting the transponder on a foam rubber mount that spaces the transponder away from and electrically isolates the transponder from the first structure.

17. The method of claim 13 further including the steps of:
sensing acceleration of the vehicle and providing safing signals indicative of the sensed acceleration; and
determining the occurrence of a vehicle crash condition when both the response signals and the safing signals indicate a vehicle crash condition.

18. The method of claim 13 wherein the transponder is a first transponder and the transceiver is a first transceiver and wherein the method further including the steps of:
operating the first transponder and the first transceiver at a first frequency;
providing a second transponder and a second transceiver that operate at a second frequency different from the first frequency; and
monitoring received response signals received at the first and second transceivers to determine whether a vehicle crash condition is occurring.
